(19) United States
(12) Patent Application Publication
(10) Pub. No.: US 2007/0176773 A1
(43) Pub. Date: Aug. 2, 2007

(54) Rfid spoilage sensor for packaged food and drugs

(76) Inventors: Maria Smolander, Espoo (FI); Heikki Seppa, Helsnki (FI); Eero Hurme, Espoo (FI); Timo Varpuna, Vantaa (FI); Juha-Maiti Saari, Espoo (FI); Ilkka Suni, Espoo (FI); Jorma Sammi, Espoo (FI); Pani Majander, Tiilaa (FI)

Correspondence Address: BIRCH STEWART KOLASCH & BIRCH, PO BOX 747, FALLS CHURCH, VA, 22040-0747, US

(21) Appl. No.: 10/495,927

(22) PCT Filed: Nov. 15, 2002
(86) PCT No.: PCT/FI02/00911

§ 371 Date: Jun. 23, 2004

(30) Foreign Application Priority Data
Nov. 19, 2001 (FI) 20012243

(51) Int. Cl. G08B 1/08; G08B 13/14

(52) U.S. Cl. 340/539.26; 340/572.1

(57) ABSTRACT

The present invention relates to a remotely readable sensor (22) for indication of usability condition of perishable products such as foodstuffs and medical drugs. The sensor incorporates an element responsive to the condition of the perishable product. According to the invention, the sensor (22) is placed inside the foodstuff package.

The invention relates to a sensor according to the preamble of claim 1.

The invention also relates to a method according to claim 11, a system according to claim 23 and use according to claim 32.

In a package, the most stringent demands for many kinds of packaged foodstuffs include a hermetic seal, low oxygen content and sufficiently low storage temperature of the foodstuff package. If the protective gas of a gas-filled package leaks out from the package, oxygen which is a deleterious agent as to the extended acceptable quality of most products can enter the package, whereby the prolonged aging time gained by the initial protective gas filling is lost. Also in vacuum packages, the access of oxygen into the package is undesirable. In addition to the integrity and storage temperature of the package, a high quality of the raw material used is an essential factor particularly in unheated products as to the preservation of the sensory and microbiological quality. With the spoilage of a product, the microbial activity releases a large number of volatile compounds and compounds remaining in the product, whereby the quality and quantity of such compounds are determined by the character and chemical composition of the foodstuff product in combination with the microbial species causing spoilage. The compounds thus generated on one hand can affect the sensory acceptability of the foodstuff quality and on the other hand serve as quality indicators of the microbiological quality of a foodstuff product. The composition of the compounds formed in spoilage depends on the type of the foodstuff and, in the decay of poultry products for instance, different kinds of sulfur compounds (e.g., hydrogen sulfide, dimetylsulfide and dimetyldisulfide) are typically found.

Prior-art applications of RFID technology into packaging comprise theft detectors and identification tags.

Sensors employed in these applications are ultimately disposed of or deactivated in a controlled fashion, whereby these sensor embodiments lack the ability of detecting cumulative effects such as spoilage in the interior of a foodstuff package.

Conventional indicators developed to react on an increasing amount of compounds released by foodstuff decay or on increasing oxygen content in the package utilize a visible change of color. The primary function of such indicators is to help a consumer assess the quality of the product at the instant of purchase or at home. On the other hand, it would be an advantage in the wholesale or retail stage to secure the hermetic seal of packages and quality of products in the packages already prior to offering the product to a consumer.

From patent publication WO 95/33991 is known an embodiment wherein the indicator includes an electronic circuitry and a display typically integrated with the indicator construction. Alternatively, the indicator may include an output channel for taking the sensor signal over a galvanic connection to an external measurement device. This kind of an indicator with a dedicated display is necessarily an expensive solution. Moreover, passing a sensor signal to an external device over a conductor line is a very clumsy technique of retrieving information on individual foodstuff packages.

Among others, patent publications U.S. Pat. No. 5,443,987, WO 9821120, EP 0666799, U.S. Pat. No. 4,169,811 and WO 9904256 disclose indicators based on displaying a change in the indicator color or visual look at the spoilage of the product and/or change in the oxygen content of the package.

From patent publication U.S. Pat. No. 5,663,072 is known an arrangement wherein an addition of suitable chemicals is utilized in the assessment of the condition of a meat package from the absorption or reflection properties of the package itself under exposure to electromagnetic radiation. However, the compatibility of such chemicals with foodstuffs may be problematic and, furthermore, the measurement method is rather inaccurate.

As none of the hydrogen sulfide indicators known in the art are readable by RF techniques, they cannot be placed inside a foodstuff package so as to be noninvasively readable without breaking/touching the package.

Patent publication WO 01/25472 discloses an arrangement wherein a sensor readable by RF techniques is used for measuring a temperature-time integral, e.g., in order to estimate the spoilage of foodstuffs. In this system, the properties of the RF sensor placed outside the packages change cumulatively as the resistance of a biologically active material connected to the sensor varies with temperature. Inasmuch as the sensor itself is of a biologically active type, it cannot be placed inside a foodstuff package. Hence, the sensor monitors a variable (ambient temperature integral) that is known to correlate with spoilage but makes the sensor unsuitable for measuring the actual spoilage phenomenon. As a result, this embodiment is not able to identify situations in which the raw materials of the packaged product have already been defective as to their quality thus inducing a faster decay than normally expected.

It is an object of the present invention to eliminate the problems hampering the prior-art techniques and to provide an entirely novel type of sensor and method for indicating the condition of perishable products such as foodstuffs in particular.

The goal of the invention is achieved by virtue of placing into a foodstuff package a remote readable sensor based on an electric resonant circuit whose detector element sensitive to the variable to be measured is selected to be responsive to cumulative decay of a product thus making it possible to indicate the decay process in a direct and reliable fashion.

Accordingly, the essential component in an embodiment of the invention is a disposable sensor adapted to be locatable inside a foodstuff package so as to be remotely readable by RF techniques for indication of quality of a packaged foodstuff (in a sealed air-filled package, protective atmosphere package or vacuum package) by virtue of directly reacting with compounds generated in the atmosphere of the foodstuff package due to the microbiological decay of the foodstuff (particularly with hydrogen sulfide, other sulfur compounds and the like compounds capable of changing the resistance of a silver thin film).

The sensor according to the invention may also react so as to be responsive to increased oxygen content in the atmosphere of the package due to a leak or break in the package.

More specifically, the sensor according to the invention is characterized by what is stated in the characterizing part of claim 1.

Furthermore, the method according to the invention is characterized by what is stated in the characterizing part of claim 11, the system according to the invention is characterized by what is stated in the characterizing part of claim 23 and the use according to the invention is characterized by what is stated in the characterizing part of claim 32.

The invention offers significant benefits.

With the help of the electronic remotely-readable foodstuff package sensor according to the invention, the use of smart packages can be promoted in quality control from a production plant via a transportation chain to the warehousing and retail steps.

The quality control operations can be implemented in a predictive and effective fashion so that spoiled products can be discarded prior to offering them to consumers. By virtue of remote read/identification, quality control may be accomplished already in the production plant or, alternatively, for instance as a standard operation incorporated with the initial handling of goods at the firm's receive section, whereby spoiled goods can be reliably identified irrespective of the location of the spoilage sensor. In a possible alternative or complementary step, product quality control may also be carried out at the cash terminal counters.

A further advantageous benefit of the invention is that a consumer has no chance of seeing the “tripping” of the spoilage indicator, whereby spoiled products already placed on displays in a shop can be inconspicuously picked away from among the overall inventory of displayed products. Also a final quality control at the cash terminal can be used to prevent customers from receiving spoiled products.

By virtue of the invention, also the conventions related to the “Use by” date can be refined to represent more accurately the actual freshness of foodstuff products.

In the following, the invention will be examined with the help of exemplifying embodiments illustrated in the appended drawings in which

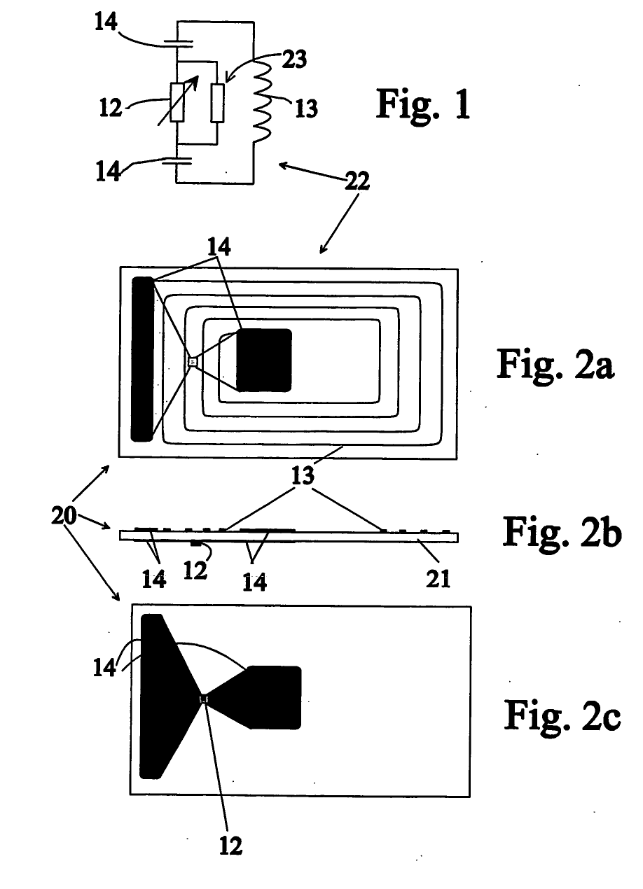

FIG. 1 shows the schematic diagram of an embodiment of the sensor according to the invention;

FIG. 2a shows an embodiment of the sensor according to the invention viewed from the direction of the device coil;

FIG. 2b shows the sensor of FIG. 2a in a side view;

FIG. 2c shows the sensor of FIG. 2a viewed from the direction of the sensor element;

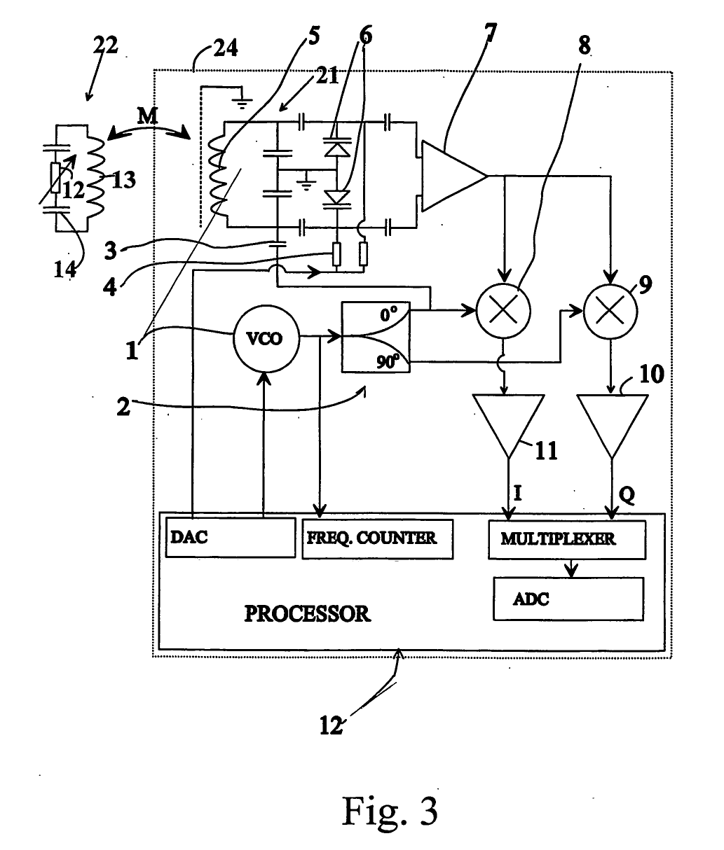

FIG. 3 shows the schematic diagram of an entire system according to the invention;

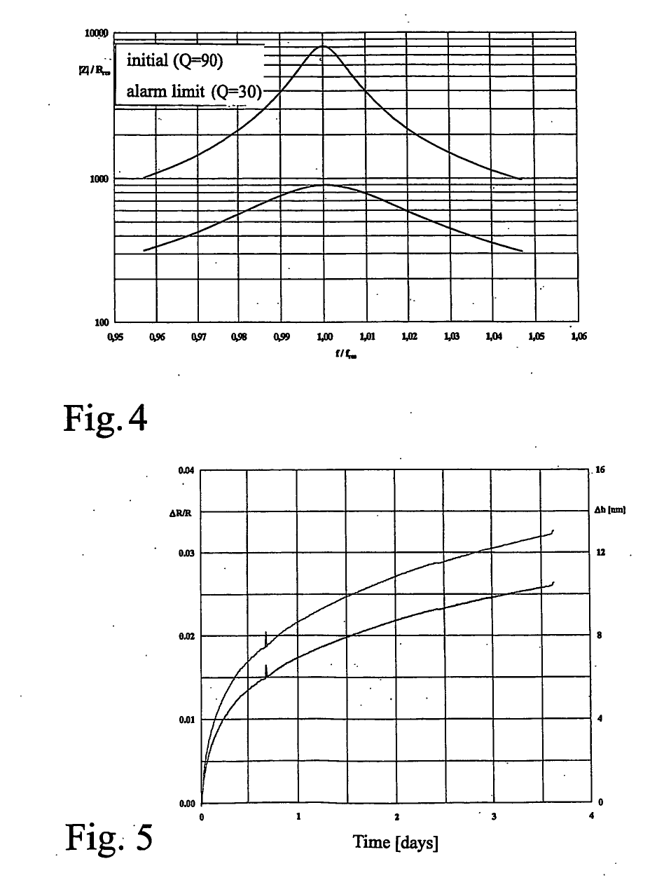

FIG. 4 shows a plot of the absolute value of the sensor impedance as a function of frequency normalized relative to the sensor resonant frequency (fᵣₑₛ) and losses (resistance Rᵣₑₛ) of the circuit at the measurement frequency;

FIG. 5 shows a plot of a first case of the relative change of resistance in the silver thin film as a function of time in a dry nitrogen atmosphere;

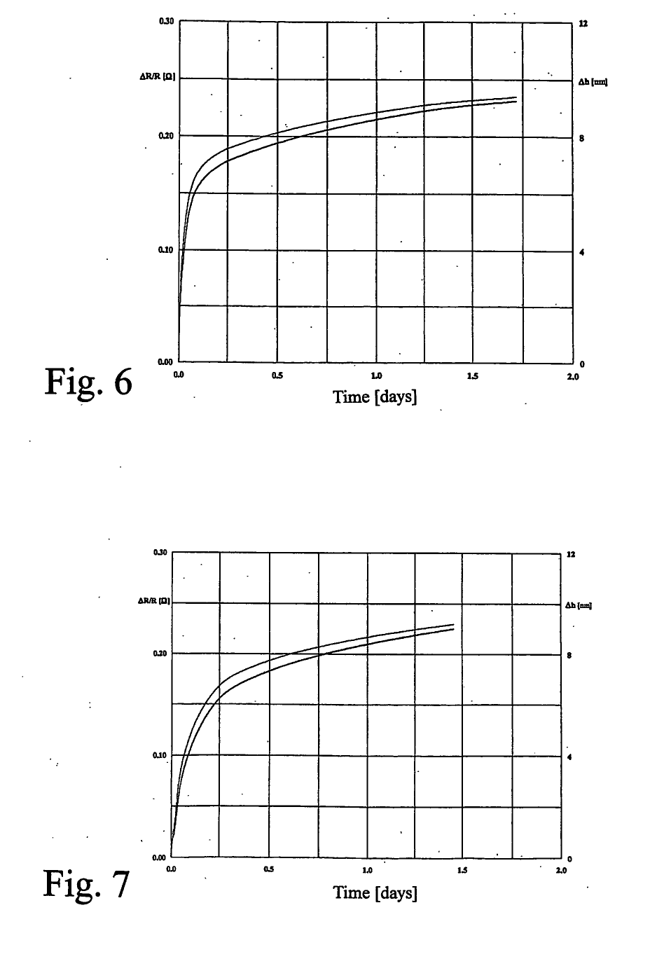

FIG. 6 shows a plot of a second case of the relative change of resistance in the silver thin film as a function of time in a nitrogen atmosphere having the relative moisture content controlled to 80%;

FIG. 7 shows a plot of a third case of the relative change of resistance in the silver thin film as a function of time in a nitrogen atmosphere having the relative moisture content controlled to 80%;

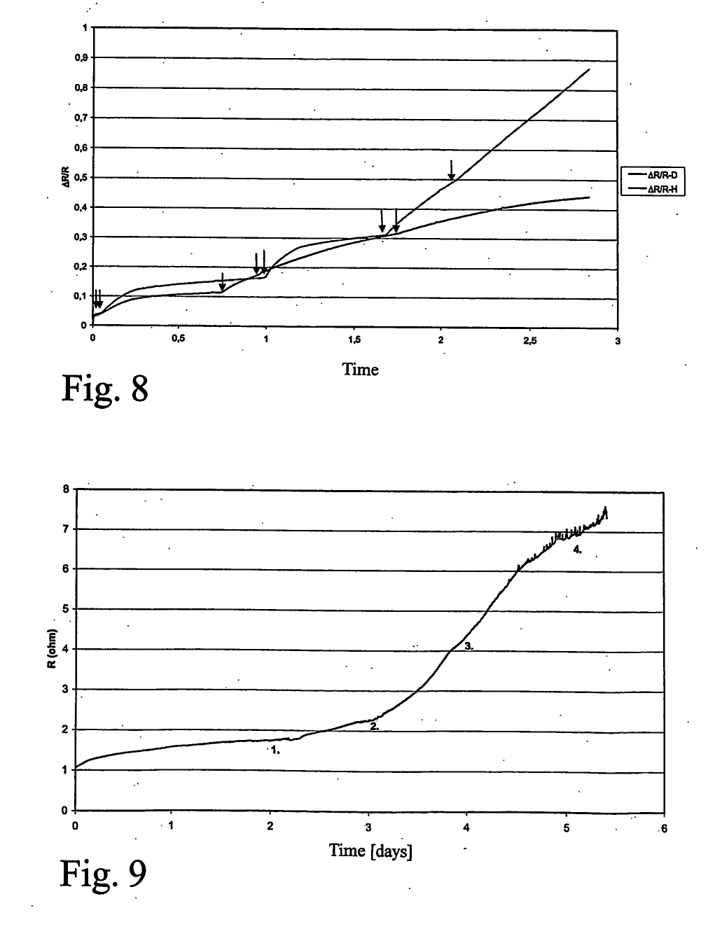

FIG. 8 shows a plot of a fourth case of the relative change of resistance in the silver thin film as a function of time in a nitrogen-carbon dioxide atmosphere (40%/60%), as well as in a dry and moist nitrogen atmosphere; and

FIG. 9 shows a plot of a fifth case of the relative change of resistance in the silver thin film as a function of time in a nitrogen-carbon dioxide atmosphere (40%/60%) serving as a protective atmosphere for foodstuffs packaged therein.

Referring to FIG. 1, therein is shown a schematic circuitry of a sensor embodiment according to the invention. The sensor 22 comprises a coil 13, series capacitors 14, and a sensor resistor 12 in parallel with a fixed resistor 23. This circuitry represents an alternative embodiment of the invention. The gaseous compound to be detected corrodes the sensor resistor, whereby its resistance increases. Knowing the measurement frequency, inductance of coil 13 and resistance of fixed resistor 23, the value of the sensor resistor can be readily determined by measuring the full-width half value of the resonant frequency of the resonant circuit. Next, a situation may be contemplated having no fixed resistor 23 in parallel with the sensor resistor 12. Should the sensor resistor corrode up to a point of a very high resistance, the resonant circuit would cease to function. As a result, its existence could not be detected by a reader device. Hence, the fixed resistor 23 in parallel with the sensor resistor 12 assures full function of the resonant circuit 22 even after the sensor resistor 12 has corroded nonconductive. The parallel resistor 23 may be a discrete component or, alternatively, e.g., a portion of the sensor resistor 12 protected against oxidation/corrosion but electrically functioning in parallel with the sensor resistor 12.

As shown in FIG. 2, a practicable embodiment of sensor 22 according to the invention comprises a planar coil 13 fabricated on a polymer laminate, two capacitors 14 having their planar electrodes placed on both sides of the laminate and a sensor resistor 12. The sensor resistor 12 is connected over the planar electrodes of capacitors 14 by bonding or gluing with a conductive adhesive. The parallel resistor 23 of FIG. 1 is omitted from the embodiment of FIG. 2.

A reader device 24 is used for measuring the impedance of sensor 22 as a function of frequency. The frequency range swept in this application covers a band (7-9 MHz) centered about the sensor circuit resonant frequency. The reader device processor computes the resonance full-width half-value of the frequency-response impedance curve of the sensor circuit. Based on this information, it is further possible to derive the value of the sensor's variable resistor assuming that the properties of the sensor is coil remain constant.

Referring to FIG. 3, the following text describes the function of the sensor and the reader device 24 thereof. Coil 13 of sensor 22 is magnetically coupled by the mutual inductance (M) to the antenna coil 5 of reader device 24 that forms a portion of the resonant LC circuit 21. RF current to resonant circuit 21 is fed from a voltage-controlled oscillator 1 via directional coupler 2 and coupling capacitor 3. The frequency of oscillator 1 is varied with the help of a DA converter incorporated in processor unit 12. The resonant frequency of resonant circuit 21 of antenna 5 in reader device 24 is varied by applying the output voltage of the DA converter via resistors 4 to varicap diodes 6 of the resonant circuit. The RF voltage of the resonant circuit is amplified by a preamplifier 7 and then taken to mixers 8 and 9 of a quadrature detector. The output voltages of the mixers are filtered and amplified by amplifiers 10 and 11, whereupon they are taken via a multiplexer of the processor unit to an AD converter.

In this fashion, a change in the properties of sensor 22 due to a resistance change of resistor 12 is detected by way of computing the resonant circuit quality factor of sensor 22 and, if the quality factor falls below a predetermined value, the reader device 24 can issue an alarm. The sensor 22 is placed inside a foodstuff package, wherein its active element 12 communicates directly with the foodstuff or a solution/gas enclosing the same. Hence, the perishable foodstuff can directly affect the properties of sensor element 12 so as to cumulatively change its measured value by oxidation or corrosion.

In FIG. 4 is plotted the absolute value of the sensor impedance as a function of frequency normalized relative to the sensor resonant frequency (fᵣₑₛ) and losses (resistance Rᵣₑₛ) of the circuit at the measurement frequency.

Based this technique, the invention provides a disposable spoilage sensor that can be placed in a foodstuff package so as to be remotely readable without opening/touching the package. The remote read technique makes it possible to generate an unambiguous “Accept/Reject” signal. Additionally, the sensor according to the invention allows the condition of a foodstuff/package to be checked, e.g., individually identifiably by unit or case in a production plant, warehouse and/or retail shop without touching the packages. In a retail shop, an individual package can be checked by means of a remote reader device incorporated with a chilled display cabinet or cash register counter.

The function of a sensor according to the invention responsive to a spoilage-indicating compound formed in the microbiological decay of a foodstuff (typically hydrogen sulfide or the like sulfur compound or any compound reacting with a silver thin film) is based on a change in the conductivity (resistive loss) of a silver-containing material when the silver moiety is converted into silver sulfide in the presence of hydrogen sulfide. The sensor is implemented by fabricating a resonant LC circuit from the silver-containing material such that the quality factor of the circuit changes in the presence of sulfur compounds (particularly hydrogen sulfide) as the silver particles are converted into silver sulfide.

A resonant LC circuit made from a silver-containing material can be realized by way of, e.g., sputtering a thin film of silver. Typically, the thickness of the thin film is 10 to 500 nm. The optimal thickness of the thin film is in the range of 15-50 nm.

The change of resistance in a resonant LC circuit can be detected using similar electronic techniques as those employed for reading concurrent intrusion detectors or 13.5 MHz RFID tags.

The function of an oxygen-responsive sensor can be based on the change of conductivity or capacitance (permittivity) in a suitable material (e.g., a metal, metal oxide, redox indicator dye or conductive polymer) in the presence of oxygen. Such an oxygen-responsive sensor can be realized, e.g., as a thin-film sensor having a thin film element made from iron. To prevent oxidation during the storage of the sensor and in the foodstuff packaging phase, the sensor can be protected by a foil of controlled oxygen permeability. Also in this kind of an oxygen-responsive sensor, the change of its properties can be detected using such electronic techniques as are employed for reading concurrent intrusion detectors or 13.5 MHz RFID tags.

The invention is elucidated in the following exemplary embodiment.

### EXAMPLE 1

### Formation of Hydrogen Sulfide in the Gas Space of Sealed Chicken Strip Packages

Chicken strips (weight about 115:5 g) were packaged in 210 ml sealed containers (material HDPE) filled with protective gas (80% CO₂/20% N₂) and stored at controlled temperatures of +5.5° C. and +8° C. In order to analyze volatile metabolic compounds, a 5 ml gas sample was sucked from the gas spaces of each container using a gas-tight syringe and was further injected into gas-tight sealed head-space vials (volume 22 ml) in a clean room space. The hydrogen sulfide contents in the gas space of each container were determined by gas chromatography using a sulfur-selective detector.

The hydrogen sulfide content in the gas space that increases as a function of storage time and temperature (Table 1) is indicative of the freshness of chicken strips.

TABLE 1
Hydrogen sulfide content (mg/l) in a sealed gas space containing
chicken strips stored at different temperatures (quantitative
analysis limit 0.1 mg/l, n.d. = no detectable peak in chromatogram, + =
detectable peak in chromatogram, yet below quantitative analysis limit)
(n = 2).

| | | H₂S content (mg/l) in | H₂S content (mg/l) in |
|---|---|---|---|
| | | gas space at +5.5° C. | gas space at +8° C. |
| Storage time | | storage temperature | storage temperature |
| 0 | d | n.d. | n.d. |
| 5 | d | n.d. | n.d. |
| 7 | d | n.d. | + |
| 9 | d | + | 0.2 |
| 12 | d | 0.15 | 0.75 |

### EXAMPLE 2

### Effect of Hydrogen Sulfide on the Resistance of Silver Thin Films in Nitrogen Atmosphere

The effect of hydrogen sulfide on silver thin-film resistors of different thicknesses was measured in a measurement chamber of relatively high gas-tightness equivalent to a foodstuff package and maintained at a controlled temperature +4° C. (±0.02° C.). Nitrogen was used as the protective atmosphere in the chamber. The measurement equipment comprised generally an RLC bridge, while for lower resistance values a four-terminal resistance meter was employed.

In FIG. 5 is shown the relative resistance change of the silver thin film as a function of time in a dry nitrogen atmosphere. The thickness of the silver thin film was 508 nm, hydrogen sulfide content of gas space 0.54 mg/l and temperature +4° C.

In FIG. 6 is shown the relative resistance change of the silver thin film as a function of time in a nitrogen atmosphere having a moisture content of 80%. The thickness of the silver thin film was 50 nm, hydrogen sulfide content of gas space 0.54 mg/l and temperature +4° C.

In FIG. 7 is shown the relative resistance change of the silver thin film as a function of time in a nitrogen atmosphere having a moisture content of 80%. The thickness of the silver thin film was 50 nm, hydrogen sulfide content of gas space 0.11 mg/l and temperature +4° C.

### EXAMPLE 3

### Effect of Hydrogen Sulfide on the Resistance of Silver Thin Films in a Gas Mixture Atmosphere of Nitrogen and Carbon Dioxide

The effect of hydrogen sulfide on 50 nm thick silver thin-film resistors was measured in a measurement chamber of relatively high gas-tightness equivalent to a foodstuff package and maintained in a chilled cabinet (+6° C.). A mixture of nitrogen and carbon dioxide that typically is employed as a protective gas in sealed meat product packages was used as the protective atmosphere in the chamber. Hydrogen sulfide was added in steps into the reaction chamber. A digital four-terminal resistance meter was used for measurements.

In FIG. 8 is shown the relative resistance change of a silver thin film as a function of time in a nitrogen-carbon dioxide (40%/60%) atmosphere. The thickness of the silver thin film was 50 nm, hydrogen sulfide content in the gas space after the successive addition steps of hydrogen sulfide: 0.07 mg/l after step 1, 0.2 mg/l after step 2, 0.47 mg/l after step 3 and 1.0 mg/l after step 4 (resistance changes: ΔR/R−D=resistance change in dry atmosphere, ΔR/R−H=resistance change in moist atmosphere of 80%).

### EXAMPLE 4

### Resistance Change of Silver Thin Films in the Gas Space of a Chicken Strip Package Filled with a Protective Gas Mixture of Nitrogen and Carbon Dioxide

The effect of compounds released during spoilage on 50 nm thick silver thin-film resistors was examined by placing the silver thin-film resistor together with an aliquot (50 g) of chicken strips into a container (volume 120 ml, material HDPE). At the packaging instant, the recommended remaining shelf life of the chicken strips was 5 days. The protective gas filing in the container was a mixture of nitrogen and carbon dioxide (40%/60%). The container with the chicken strips therein was stored in a chilled cabinet. The resistance of the silver thin-film resistor as a function of time was measured using a digital four-terminal resistance meter as the measurement device. Simultaneously with the progress of the test on the package incorporating a sensor, sensory evaluation of the smell, particularly the sulfurous smell, released by chicken strips packaged in similar containers was performed.

In FIG. 9 is shown the resistance change of a silver thin film as a function of time in the gas space of a container (120 ml) filled with a nitrogen-carbon dioxide mixture (40%/60%) atmosphere and having chicken strips (50 g) packaged therein. The sensory quality of the product was evaluated on the following scale: grade 1=any (1 out of 3) of the reference packages stored under similar conditions released egg-like smell indicating slight aging, grades 2 and 3=all of the reference packages released egg-like smell of an aged product indicating an outdated but not spoiled product (as judged by 3 test persons), grade 4=smell indicating spoilage (“Use by” date).

RF technology can be utilized for implementing a plurality of foodstuff package sensors based on different responsive materials. In Table 2 are given examples on sensor materials with compounds affecting their properties so as to indicate the freshness status of a package and/or a packaged product. In addition to the compounds mentioned in Table 1, a change in the electrical properties of a sensor may also be caused, e.g., by ethanol, organic acids or volatile amines. The sensor may also be implemented using other materials than those mentioned in Table 2, such as aluminum or copper, for instance. As the resistive properties of the sensor materials listed in the latter table change in a cumulative fashion due to product spoilage, they can be used, e.g., as the cumulatively changing resistive circuit element 12 of FIG. 3.

TABLE 2
Examples of freshness sensors of foodstuff
package readable by RF technology.

| | Compounds | | Phenomenon |
|---|---|---|---|
| | affecting elec- | | indicated by change |
| | trical proper- | Change occurring in | in electrical prop- |
| Sensor | ties of sensor | electrical property of | erty of sensor |
| material | material | sensor material | material |
| iron | oxygen | change in quality factor | leakage or breakage |
| | | of iron-containing | of package (i.e., |
| | | resonant LC circuit due | entry of oxygen into |
| | | to oxidation of iron | package), including |
| | | | subsequent spoilage |
| | | | of foodstuff |
| silver | sulfur com- | change in quality factor | spoilage of foodstuff |
| | pounds | of silver-containing | and release of vola- |
| | | resonant LC circuit due | tile compounds due |
| | | to formation of silver | to microbial |
| | | sulfide | activity |

1. A remotely by RF techniques readable sensor (22) for indication of usability condition of perishable products such as foodstuffs and medical drugs, comprising
a sensor circuit (22) of a resonant LC circuit type incorporating
an element (12) responsive to the condition of said perishable product such that
the properties of said element change in a cumulative fashion as a function of a selected measurement variable,
characterized in that
said element (12) is such in which its electrical properties change cumulatively as a direct function of the degree of product spoilage either due to a reaction related to product spoilage or under the effect of oxygen or other undesirable gas or liquid.

2. The sensor (22) of claim 1, characterized in that said cumulatively changing element (12) is a resistor having a resistance adapted to change cumulatively as a function of product spoilage or ambient oxygen content.

3. The sensor (22) of claim 1 or 2, characterized in that said cumulatively changing element (12) is a capacitor having a capacitance adapted to change cumulatively as a function of product spoilage or ambient oxygen content.

4. The sensor (22) of claim 1 or 2, characterized in that said cumulatively changing element (12) is an inductive element having an inductance adapted to change cumulatively as a function of product spoilage or ambient oxygen content.

5. The sensor (22) of claim 1 characterized in that the functional material of said cumulatively changing element (12) is silver.

6. The sensor (22) of claim 1 characterized in that the functional material of said cumulatively changing element (12) is iron.

7. The sensor (22) of claim 1 characterized in that the functional material of said cumulatively changing element (12) is aluminum.

8. The sensor (22) of claim 1 characterized in that the functional material of said cumulatively changing element (12) is a redox-type indicator dye.

9. The sensor (22) of claim 1 characterized in that the functional material of said cumulatively changing element (12) is a conductive polymer.

10. The sensor (22) of claim 1 characterized in that the functional material of said cumulatively changing element (12) is copper.

11. A method of indicating usability condition of perishable products such as foodstuffs and medical drugs, in which method a sensor (22) remotely readable by RF techniques and capable of indicating the product condition is used for condition indication,
characterized in that
a sensor (22) is placed inside a foodstuff package.

12. The method of claim 11, characterized in that said sensor (22) incorporates a resonant LC circuit.

13. The method of claim 11 or 12, characterized in that said resonant LC circuit incorporates an element (12) whose electrical properties change cumulatively as a direct function of product spoilage or ambient oxygen content.

14. The method of claim 11 or claim 12, characterized in that said cumulatively changing element (12) is a resistor having a resistance adapted to change cumulatively as a function of product spoilage or ambient oxygen content.

15. The method of claim 11 or claim 12, characterized in that said cumulatively changing element (12) is a capacitor having a capacitance adapted to change cumulatively as a function of product spoilage or ambient oxygen content.

16. The method of claim 11 or claim 12, characterized in that said cumulatively changing element (12) is an inductive element having an inductance adapted to change cumulatively as a function of product spoilage or ambient oxygen content.

17. The method of claim 11, characterized in that the functional material of said cumulatively changing element (12) is silver.

18. The method of claim 11, characterized in that the functional material of said cumulatively changing element (12) is iron.

19. The method of claim 11, characterized in that the functional material of said cumulatively changing element (12) is aluminum.

20. The method of claim 11, characterized in that the functional material of said cumulatively changing element (12) is a redox-type indicator dye.

21. The method of claim 11, characterized in that the functional material of said cumulatively changing element (12) is a conductive polymer.

22. The method of claim 11, characterized in that the functional material of said cumulatively changing element (12) is copper.

23. A system for indicating usability condition of perishable products such as foodstuffs and medical drugs, the system incorporating a sensor (22) capable of indicating the product condition is used for condition indication,
said sensor (22) is a resonant LC circuit with cumulative indicator properties and adapted remotely readable by RF techniques, and
said system further includes an apparatus (12) for remote read of the properties of said sensor (22) using RF techniques,
characterized in that
said sensor (22) is placed inside a foodstuff package.

24. The system of claim 23, characterized in that said resonant LC circuit incorporates an element (12) whose electrical properties change cumulatively as a function of product spoilage or ambient oxygen content.

25. The system of claim 23 or 24, characterized in that said cumulatively changing element (12) is a resistor having a resistance adapted to change cumulatively as a function of product spoilage or ambient oxygen content.

26. The system of claim 23 or 24, characterized in that said cumulatively changing element (12) is a capacitor having a capacitance adapted to change cumulatively as a function of product spoilage or ambient oxygen content.

27. The system of claim 23 or 24, characterized in that said cumulatively changing element (12) is an inductive element having an inductance adapted to change cumulatively as a function of product spoilage or ambient oxygen content.

28. The system of claim 23, characterized in that the functional material of said cumulatively changing element (12) is silver.

29. The system of claim 23, characterized in that the functional material of said cumulatively changing element (12) is iron.

30. The system of claim 23, characterized in that the functional material of said cumulatively changing element (12) is aluminum.

31. The system of claim 23, characterized in that the functional material of said cumulatively changing element (12) is copper.

32. Use of RF-type sensor (22) inside a foodstuff or medical drug package for direct indication of spoilage or ambient oxygen content.
